(19) United States
(12) Patent Application Publication
(10) Pub. No.: US 2005/0223625 A1
(43) Pub. Date: Oct. 13, 2005

(54) System and method for insect abatement using gas attractant emitter

(76) Inventors: Jerry Whitlow, Savannah, GA (US); Justin Pauly, Chicago, IL (US)

Correspondence Address: BAKER & BOTTS, 30 ROCKEFELLER PLAZA, NEW YORK, NY, 10112, US

(21) Appl. No.: 11/090,628

(22) Filed: Mar. 25, 2005

Related U.S. Application Data
(60) Provisional application No. 60/521,288, filed on Mar. 26, 2004.

(51) Int. Cl. A01M 1/08; A01M 1/02

(52) U.S. Cl. 43/113; 43/139; 43/107

(57) ABSTRACT

An insect abatement system attracts and captures insects through the emission of carbon dioxide gas. The insect abatement system attaches to a lamp pole and accompanying gas burning lamp. The system routes carbon dioxide gas generated from the gas burning lamp through the lamp pole to the insect abatement assembly where the carbon dioxide is emitted to the atmosphere. The outflow of carbon dioxide gas is used as an attractant for insects. Insects are attracted to the carbon dioxide emissions which is strategically placed to lure insects near an inlet device. Attracted insects enter the insect abatement system through the inlet device and are sucked into the insect abatement system by an inflow of air created by a suction mechanism. The insects entering the insect abatement system are channeled to an insect collection device where they are captured and disabled.

### PRIORITY AND RELATED APPLICATION

This application claims priority to U.S. Provisional Patent Application Ser. No. 60/521,288, filed on Mar. 26, 2004, entitled “Insect Attracting Trap,” which is hereby incorporated by reference in its entirety.

### FIELD OF THE INVENTION

The present invention relates to methods and apparatus for attracting and disabling insects that are attracted to carbon dioxide emanations.

### BACKGROUND OF INVENTION

Carbon dioxide based insect abatement systems have been utilized in a variety of configurations to capture and/or kill insects. Prior art insect abatement systems use propane gas supplied from a standard propane tank to create as a fuel source for generating carbon dioxide, heat, and moisture as an insect attractant for luring and capturing to attract insects. Once the insects are captured, they The insects are disabled by collection in a trap mechanism, electrocution, or adherence to an adhesive substance.

Insect traps have been configured to be stand-alone units that can be easily and frequently moved from one location to another. As a result, these types of units are self-contained and provide their own power supply and fuel source, typically through a standard generator and propane tank. Because these units are stand-alone they must hold all of the unit's components within a self-supporting and self-contained unit, including fuel supply, heating chamber, suction mechanism, and collection device. Self supporting containment makes such units large and not aesthetically pleasing to view. Self-contained units also have durational limits on continuous operation because their fuel source and/or power supply must be replenished.

### SUMMARY OF THE INVENTION

It is the object of the present invention to provide an insect abatement system that will safely and effectively reduce the amount of insects within an inhabited area. It is further an object of the present invention to provide a simple, cost effective, efficient and compact aesthetically attractive insect abatement system.

In accordance with an exemplary embodiment of the present invention, an insect abatement system can be incorporated into a new or existing natural gas fueled illuminating lamp and accompanying lamp pole. The natural gas fueled lamp generates carbon dioxide, which can be used as a lure for attracting and trapping insects. The natural gas fueled lamp attaches to an accompanying lamp pole with an integrated insect abatement system comprising, among other things, an input suction mechanism, a suction chamber, and an insect collection device. Insects are drawn to the carbon dioxide fumes that are output from the abatement system.

In accordance with the present exemplary embodiment, the carbon dioxide created by the natural gas fueled lamp can be internally routed using a combination of free and forced convection. An output of carbon dioxide can be strategically placed to lure insects into a position where they can be sucked into the insect abatement system by the airflow created by the input suction mechanism. As an alternative embodiment of the present invention, attractants other than carbon dioxide, for example octanel, may be incorporated into the present exemplary embodiment of the insect abatement system.

In accordance with the present exemplary embodiment, a natural gas source can be directly connected to the lamp, such that there would be no need to use and replace propane filled tanks as a fuel source.

In accordance with the present exemplary embodiment, the insect abatement system comprises, among other things, a suction chamber that can include two mirrored parts that can be attached to the lamp pole without any modification to the lamp pole itself.

In accordance with the present exemplary embodiment, the combustion of natural gas can provide the power to operate a suction mechanism, such as a modified turbine or fan, as well as generating the carbon dioxide used for attracting the insects. The suction mechanism can be used to create the airflow for sucking the insects into the abatement system. As an alternative embodiment, the suction mechanism may also be used to shred the insects that are sucked into the abatement system instead of using an insect collection device for the collection of whole insects.

In an alternative embodiment of the present invention, the insect abatement system could utilize solar panels to generate direct current (DC) electricity to power the suction mechanism. As an alternative, a rechargeable battery may also be included to store any unused energy collected by the solar panels.

In accordance with the present exemplary embodiment, the natural gas fueled lamp can attach to an accompanying lamp pole. The integrated insect abatement system comprising, among other things, an input suction mechanism, an inlet for the entry of insects, a suction chamber, an outlet for the outflow of carbon dioxide fumes, and an insect collection device, may be integrated into the lamp pole and located at a distant remote from the gas fueled lamp. For example, the gas fueled lamp may be positioned atop the lamp post, and the integrated abatement system may be positioned at a location near the base, or lower portion of the lamp post. A conduit device for routing exhaust could be routed internally within the lamp post thereby conveying the carbon dioxide emitted from the gas fueled lamp to the integrated abatement system.

In accordance with the present exemplary embodiment, the insect abatement system does not require a supporting frame independent of the lamp post to which it is integrated. It is further an object of the present invention that a combustion chamber is not required, or need be integrated with the insect abatement system. As such, the present exemplary embodiment does not require an independent supporting frame or a combustion chamber supported thereon.

In an alternative embodiment of the present invention, the natural gas fueled lamp can attach atop the accompanying lamp pole, and the integrated abatement system may be positioned at a location near the gas fueled lamp, or upper portion of the lamp post. A conduit device for routing exhaust could be routed internally within the lamp post thereby conveying the carbon dioxide emitted from the gas fueled lamp to the integrated abatement system.

In accordance with the present exemplary embodiment, the lamp post may comprise a vertical post, a base upon which the post may be affixed, tubing or similar device for routing exhaust, a valve, a burner, a chimney, a chimney holder, a mantle, and a globe.

Although the present invention has been described in considerable detail with reference to certain preferred embodiments thereof, variations and refinements are possible without departing from the spirit of the invention. Therefore, the scope of the invention should be limited only by the appended claims and their equivalents.

### BRIEF DESCRIPTION OF DRAWINGS

FIG. 1A is an elevation view which illustrates an insect abatement apparatus integrated into a lamp pole with an accompanying gas burning lamp.

FIG. 1B is a side elevation view which illustrates the apparatus and lamp pole assembly shown in FIG. 1A.

FIG. 1C is a rear elevation view which illustrates the apparatus and lamp pole assembly shown in FIGS. 1A and 1B.

FIG. 2A is section view which illustrates a close-up view of the insect abatement apparatus shown in FIGS. 1A, 1B and 1C.

FIG. 2B is a section view which illustrates a close-up view the insect abatement apparatus shown in FIG. 2A.

FIG. 3A is a section view which illustrates an exemplary embodiment of the insect abatement apparatus attached to a lamp pole.

FIG. 3B is a plan view which illustrates an exemplary embodiment as shown in FIG. 3A.

FIG. 3C is a section view which illustrates a close-up view of the of the insect abatement apparatus shown in FIGS. 3A and 3B.

FIG. 4A is a plan view which illustrates an exemplary embodiment of the insect abatement apparatus integrated into a lamp pole with an accompanying gas burning lamp.

FIG. 4B is a section view which illustrates an exemplary view of the insect abatement apparatus shown in FIG. 4A.

FIG. 5A is a side elevation view which illustrates a natural gas burning lamp enclosure.

FIG. 5B is an elevation view which illustrates an exemplary view of the natural gas burning lamp enclosure shown in FIG. 5A.

FIG. 5C is an elevation view which illustrates an exemplary view of the natural gas burning lamp enclosure shown in FIGS. 5A and 5B.

FIG. 6 is an assembly view which illustrates the insect abatement apparatus and natural gas lamp assembly.

### DETAILED DESCRIPTION OF THE PREFERRED EMBODIMENT

It is the object of the instant invention to provide an insect abatement system that can be incorporated into a new or existing lamp pole. Lamp poles that accommodate natural gas fueled illuminating lamps can be modified such that the gas fueled lamp provides a source of carbon dioxide to the insect abatement system as an attractant. A natural gas fueled lamp generates carbon dioxide when it produces a flame for illumination purposes. The carbon dioxide by-product can be used as a lure for attracting insects to the insect abatement system where the insects are subsequently trapped and disabled. It is a further object of the instant invention to provide a simple, compact, and cost effective insect abatement system that is easily attachable to a variety of lamp pole designs, which can utilize the carbon dioxide gas by-product of a gas burning lamp.

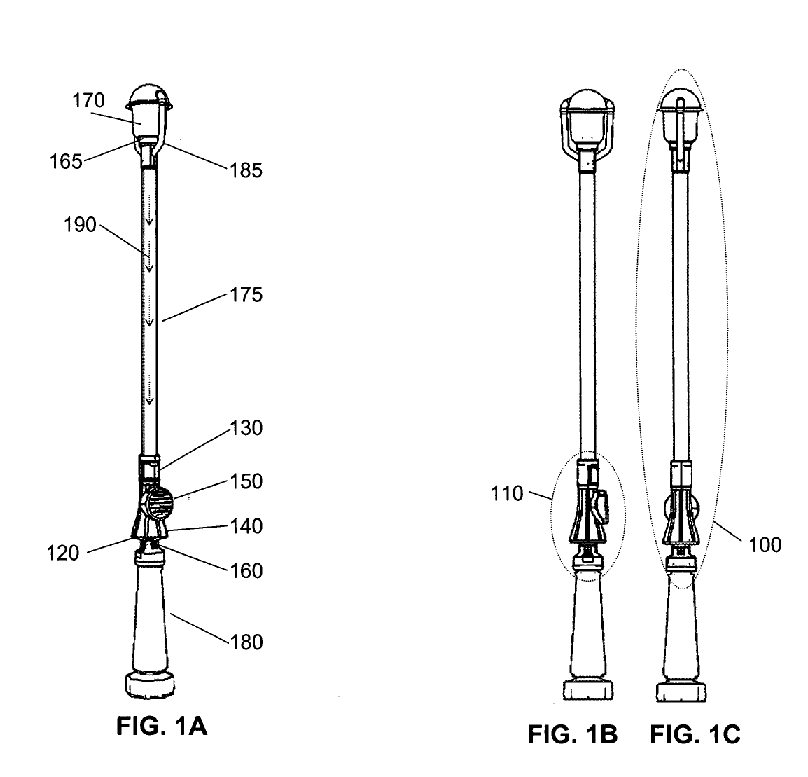

Referring to FIGS. 1A, 1B and 1C, an embodiment of an insect abatement assembly 110 is incorporated into a natural gas fueled lamp 170 and accompanying lamp pole 175 to produce an insect abatement system 100. A natural gas fueled lamp 170 is mounted on top of the lamp pole 175. The gas fueled lamp 170 operates on natural gas and produces a flame. A source of natural gas used by the lamp 170 can be directly connected to the lamp through any commonly known method within the art of delivering natural gas. This direct delivery of natural gas allows the gas fueled lamp to operate continuously without replacement, such as would be required if a portable type gas source was used. As the gas fueled lamp 170 burns the natural gas by producing a flame, carbon dioxide gas (“CO2”) is generated. The CO2 generated from the operating gas fueled lamp 170 is channeled through an exhaust conduit 185 into the lamp pole 175. The lamp pole 175 is used as an exhaust route 190.

The CO2 is routed through the exhaust route 190 to an insect abatement assembly 110, where the CO2 is emitted to the atmosphere through an outlet device 160. The lamp pole 175, to which the insect abatement assembly 110 is attached, rests atop a lamp pole base 180. The lamp pole base 180, however, is not a critical feature to the operation of the insect abatement system 100, and as such, an exemplary embodiment of the instant invention would operate without a lamp pole base 180. In a preferred embodiment the exhaust route 190 comprises a separate conduit that attaches to the exhaust conduit 185, and located within the lamp pole 175.

After the lamp 170 generates CO2, the CO2 is routed from the gas fueled lamp 170 through the exhaust conduit 185 to the lamp pole 175 via the exhaust route 190 by using a combination of free and forced convection. As the lamp 170 burns and generates CO2, the lamp 170 draws air into the lamp housing through the exhaust inlet 165. The air in-flow helps channel the CO2 into the exhaust conduit 185 that is located above the lamp 170. Once the CO2 enters the exhaust conduit 185, it is channeled through the lamp pole 175 via the exhaust route 190 through the use of free convection and gravity. Because CO2 is heavier than air, gravity naturally channels the CO2 through the exhaust route 190 to the exhaust outlet 160. In a preferred embodiment, as the CO2 gravitates in the downward direction through the lamp pole 175 via the exhaust route 190 and towards the outlet device 160, an in flow of air entering the exhaust inlet 165 may be created from air being sucked into the top of the lamp 170 and through the exhaust route 185. This airflow, or forced convection, can assist the channeling of the CO2 through the exhaust route 190 to the outlet device 160.

The CO2 is routed through the exhaust route 190 to the outlet device 160, where it is then released through the outlet device 160 and into the atmosphere. The CO2 emission is strategically placed to lure insects to a location near an inlet device 120. As an exemplary embodiment of the instant invention, attractants other than carbon dioxide, for example octanel, can be incorporated into the CO2 and exhausted through the outlet device 160 and into the atmosphere.

As the insects are lured to the emission of CO2, they approach the inlet device 120. A suction mechanism 150 creates an in-flow of air relative to the inlet device 120, which draws the insects into the inlet device 120 and into a suction chamber 140. As the air flows into the device, air is drawn from around the interior rim of the suction chamber 140. The insects are drawn through the suction chamber 140, and into an insect collection device 130. The insects are collected in the insect collection device 130, while the in-flow of air exits the insect abatement assembly 110 through an opening in the suction mechanism 150.

In an exemplary embodiment, the airflow created by the suction mechanism 150 draws the insects into the inlet device 120, through the suction chamber 140, and into the suction mechanism 150 itself where the insects are destroyed by the suction mechanism 150. In this embodiment, insect remnants are exhausted through opening in the suction mechanism 150.

FIG. 1A illustrates an embodiment of the present invention where an insect abatement assembly 110 includes an inlet device 120, an insect collection device 130, a suction chamber 140, a suction mechanism 150, and an outlet device 160. The insect abatement assembly is located at the lower portion of the lamp pole 175, near the upper portion of the lamp pole base 180. In this embodiment, the gas fueled lamp 170 is located at a distance remote from the insect abatement assembly 110 such that the exhaust route 190 channels the exhaust from the gas fueled lamp 170 through the lamp pole 175 to the insect abatement assembly 110 and to the outlet device 160.

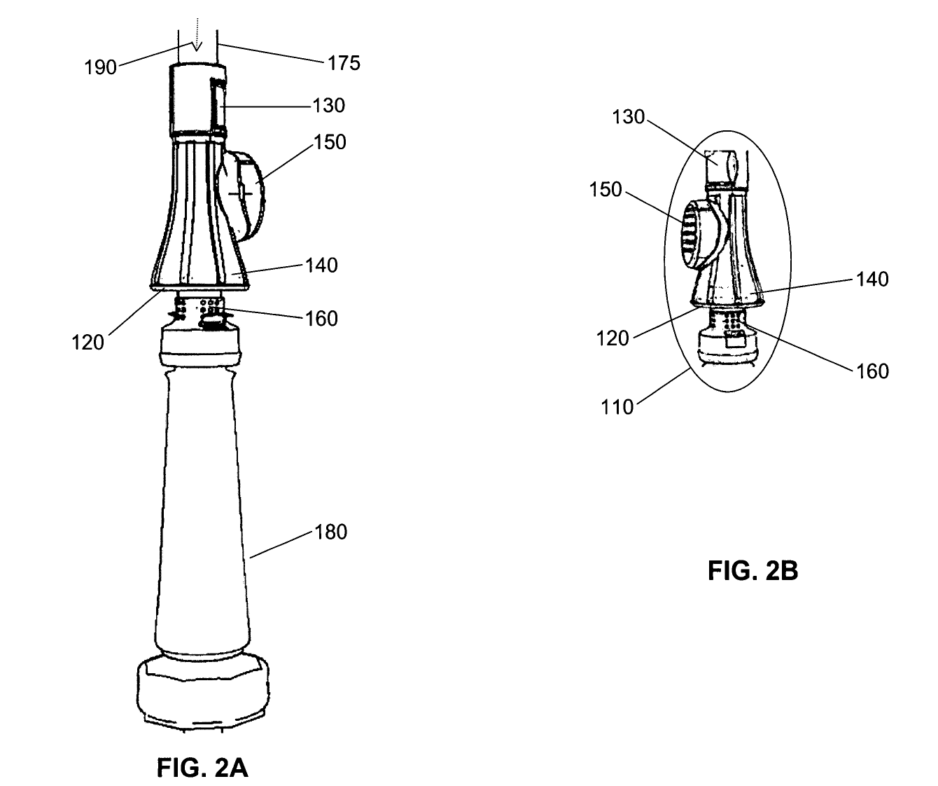

FIGS. 2A and 2B illustrate a close-up view of the insect abatement assembly 110 that is shown in FIGS. 1A, 1B and 1C. The insect abatement assembly 110 includes an inlet device 120, an insect collection device 130, a suction chamber 140, a suction mechanism 150, and an outlet device 160.

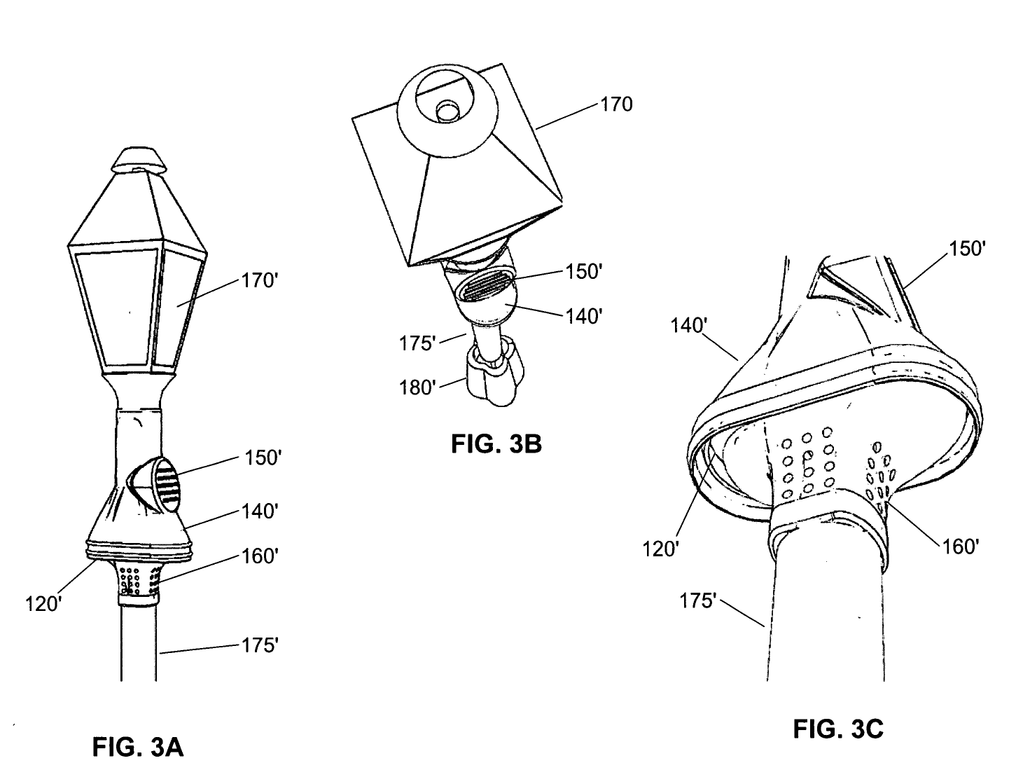

FIGS. 3A and 3B illustrate an exemplary embodiment of the present invention where an insect abatement assembly 110′ includes an inlet device 120′, an insect collection device 130′, a suction chamber 140′, a suction mechanism 150′, and an outlet device 160′. In this embodiment, the insect abatement assembly 110′ is located at a location near the gas fueled lamp 170′ or upper portion of the lamp pole 175′. FIGS. 3A and 3B further illustrate that the exhaust conduit can be contained entirely within the gas fueled lamp 170′ and the lamp pole 175′ when routed to the insect abatement assembly 110′ via the exhaust route 190′.

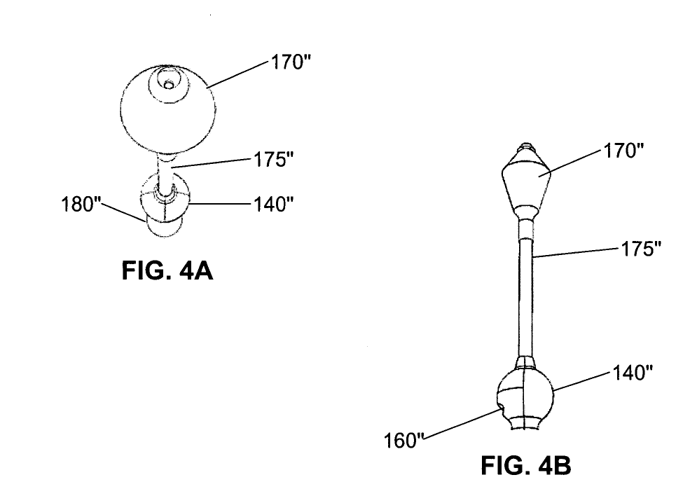

FIGS. 4A and 4B illustrate an exemplary embodiment of an insect abatement system 100 such that an insect abatement assembly 110″ can be attached to varying types of lamp pole 175″ designs. The insect abatement system 100″ illustrated in FIGS. 4A and 4B includes an inlet device 120″ an insect collection device 130″, a suction chamber 140″, a suction mechanism 150″ and an outlet device 160″. As FIGS. 4A and 4B illustrate, the insect abatement system can be attached to a variety of lamp pole and gas fueled lamp designs. This further illustrates an object of the present invention to provide a simple and compact insect abatement system that is easily attachable to a variety of lamp poles.

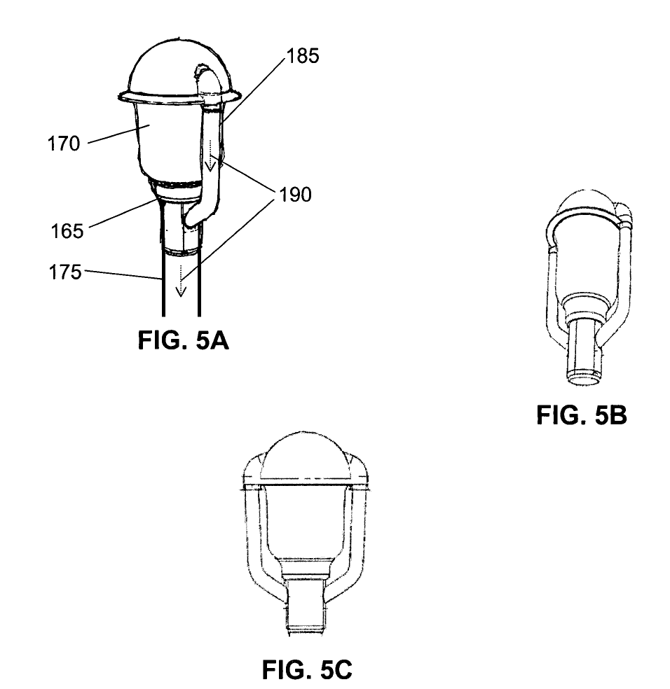

FIGS. 5A, 5B and 5C illustrate an embodiment of a gas fueled lamp 170 where the exhaust conduit 185 is external to the gas fueled lamp 170 and is routed into the lamp pole 175. The exhaust conduit 185 and lamp pole 175 are used to channel the exhaust route 190 to the insect abatement assembly 110.

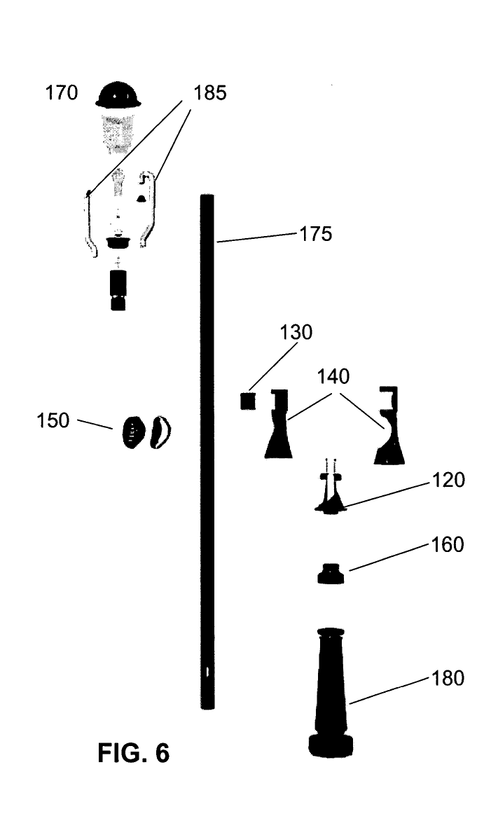

FIG. 6 is an exploded view of the insect abatement system, illustrating the individual components comprising the insect abatement system. In an exemplary embodiment, the suction chamber 140 comprises two mirrored parts that are easily attachable to a lamp pole 175. The insect collection device 130 is detachable, enabling removal of the collected insects.

Those of ordinary skill in the art will appreciate that the foregoing discussion of certain embodiments and preferred embodiments are illustrative only, and does not limit the spirit and scope of the present invention, which is limited only by the claims set forth below.

1. An insect abatement apparatus for attracting and capturing insects, comprising:
a carbon dioxide gas source capable of generating carbon dioxide gas;
a suction chamber wherein said suction chamber attaches to a lamp pole;
an outlet device connected to said suction chamber wherein said outlet device allows for the outflow of said carbon dioxide gas to the atmosphere;
an inlet device connected to said suction chamber wherein said inlet device allows for the entry of insects;
an insect collection device connected to said suction chamber wherein insects entering through said inlet device are collected;
an exhaust route contained within said lamp pole wherein carbon dioxide gas is routed from said carbon dioxide gas source to said outlet device; and
a suction mechanism for creating an inflow of air whereby air flows from the atmosphere into said inlet device through said suction chamber, and into said insect collection device for attracting and capturing insects.

2. The insect abatement apparatus of claim 1, wherein said carbon dioxide gas source is generated from a natural gas fueled burner and is affixed atop said lamp pole.

3. (canceled)

4. The insect abatement apparatus of claim 1, wherein said suction mechanism comprises a fan;

5. The insect abatement apparatus claim 1 of claim 1, wherein said suction chamber comprises mirrored parts attached to said lamp pole.

6. A method for attracting and capturing insects, comprising:
generating a carbon dioxide gas from a carbon dioxide gas source;
attaching a suction chamber to a lamp pole;
providing an outflow of carbon dioxide gas to the atmosphere through an outlet device;
providing an inlet device for the entry of insects;
routing carbon dioxide gas from said carbon dioxide gas source to said outlet device through an exhaust route contained within said lamp pole;
collecting insects entering through said inlet device in an insect collection device; and
creating an inflow of air with a suction mechanism wherein air flows from the atmosphere into said inlet device, through said suction chamber, and into said collection device for capturing insects.

7. The method of claim 6, further comprising generating said carbon dioxide gas is from a natural gas fueled burner affixed atop a lamp pole.

8. The method claim 6, further comprising creating an inflow of air with said suction mechanism comprises a fan.
